(19) United States
(12) Patent Application Publication
(10) Pub. No.: US 2006/0213883 A1
(43) Pub. Date: Sep. 28, 2006

(54) Method for severing brittle materials by lasers with asymmetric radiation density distribution

(75) Inventors: Gabriele Eberhardt, Jena (DE); Hans-Ulrich Zuehlke, Jena (DE); Uwe Weinzierl, Jena (DE); Vladimir Stephanovich Kondratenko, Moskau (RU)

Correspondence Address: REED SMITH, LLP;ATTN: PATENT RECORDS DEPARTMENT, 599 LEXINGTON AVENUE, 29TH FLOOR, NEW YORK, NY, 10022-7650, US

(73) Assignee: JENOPTIK Automatisierungstechnik Gmbh;

(21) Appl. No.: 11/387,233

(22) Filed: Mar. 22, 2006

(30) Foreign Application Priority Data
Mar. 22, 2005 (DE) 10 2005 013 783.0

(51) Int. Cl. B23K 26/38

(52) U.S. Cl. 219/121.72

(57) ABSTRACT

In accordance with the method of the invention, flat workpieces of brittle material, e.g., sapphire, glass ceramic, or glass, can be severed by inducing thermomechanical stresses, particularly along severing lines of the same direction, with a laser beam having a beam spot with asymmetric radiation density distribution on the workpiece by a relative movement in different directions in that a mirror-symmetric change in radiation density is brought about exclusively by changing the method parameters.

### CROSS-REFERENCE TO RELATED APPLICATION

This application claims priority of German Application No. 10 2005 013 783.0, filed Mar. 22, 2005, the complete disclosure of which is hereby incorporated by reference.

### BACKGROUND OF THE INVENTION

1. Field of the Invention

The invention is directed to a method for severing brittle materials by means of laser radiation based on the principle of induced thermal stresses as is known generically from DE 197 15 537 C2.

2. Description of the Related Art

As one of the hardest brittle materials, sapphire is currently chiefly used as base material in the form of wafer disks for blue LEDs. The great hardness of the sapphire base material (Moh hardness 9) and the very small chip size (approximately 300×300 μm) of the LEDs present a particularly great challenge in severing the wafer disk for separating into individual chips. Similar requirements exist for severing monocrystalline quartz (Moh hardness: 7), ceramic substrates (Moh hardness: 8-9), and glass.

The oldest method for severing hard, brittle materials is mechanical scribing with a diamond tool and subsequent breaking along the scribed notch.

For some years already, mechanical scribing has been carried out by means of UV lasers or CO₂ lasers, and an appreciable increase in productivity can be achieved in this way through high accuracy and wear-free operation. Narrow V-shaped grooves or rows of small holes are generated by ablation and can subsequently be broken in a deliberate manner.

This laser scribing method has the disadvantage that the vaporized material components are deposited at the cut edges and also that a subsequent breaking process step is necessary. The breaking causes jagged edges and corners.

A laser method in which no material is removed but, rather, the material is split through induced thermal stresses is described in EP 0 633 867 B1. In this method, the material is heated locally by a CO₂ laser with a wavelength of 10.6 μm so that compressive stresses occur in the material. The material is subsequently cooled by a directed coolant jet so as to generate tension stresses. The occurring forces in the material result in cleavage. Since no material is vaporized or removed, no impurities occur on the surface of the material or on the cut edges and there is no loss of material.

The beam spot geometry preferably has an elliptical shape with a Gaussian distribution of the radiation density which is symmetric to both semiaxes (along the severing line and perpendicular to the severing line). The heating is carried out in a very narrow area, and the temperature increases dramatically from the periphery to the center.

In order to prevent overheating in the center of the beam spot and, therefore, to avoid exceeding the softening temperature of the material, it is proposed in WO 96/20062 to use a laser beam bundle in which the radiation density on the surface of the material is distributed so as to decrease from the periphery to the center. This is intended to optimize the heating conditions of the material which, on the one hand, should ensure a more uniform heating of the entire width of the irradiated portion and, on the other hand, exclude overheating in the center. A radiation density distribution of this kind is achieved with an elliptic ring or with two elliptic beam spots with a Gaussian distribution which are arranged side by side in longitudinal direction. The positive effects of a method according to WO 96/20062 compared to a method according to EP 0 633 867 B1 are also achieved with a beam bundle in which the power density in the cross section is distributed in a practically uniform manner or is even increased only insignificantly in direction of the center. In this case, the radiation density distribution suggested in this reference is symmetric to the two semiaxes.

In DE 197 15 537 C2, a radiation density distribution corresponding to a beam spot according to WO 96/20062 is represented as causing an unfavorable temperature distribution and it is suggested that cutting be carried out with a heat radiation spot whose maximum radiation intensity lies on a V-shaped or U-shaped curve that opens toward the front end of the heat radiation spot and in which the temperature maximum lies spatially at the summit of the V-shaped or U-shaped curve.

A heat radiation spot of this kind can be generated, for example, with a circular laser beam cross section with a homogeneous or Gaussian distribution, by scanning on the workpiece surface or by means of an annular laser beam cross section with one half side cut off.

DE 198 33 368 C1 describes a method and a device in which the intensity distribution on the workpiece surface is influenced by one or more diaphragms inserted in the beam path. Compared to the prior art in which given intensity profiles are achieved by costly auxiliary optics, the solution described in this reference makes it possible to achieve a large number of different intensity distributions, which are also adapted for the application at hand, economically and with minor adjustments. For example, it is suggested to use a rotatable strip diaphragm to achieve an inner, rotationally symmetric masking of the beam bundle with a width corresponding to the angular position of the strip diaphragm. This has the disadvantage that influencing the intensity distribution always entails a loss in intensity, i.e., in order to achieve a desired power yield, a radiation source of appreciably higher output must always be used.

Further, the severing of brittle material by induced thermomechanical stresses using two or more laser beams is known from DE AS 1 244 346 and DE 199 52 331 C1 as well as from WO 96/20062, which was already described.

In the method described in DE AS 1 244 346, a determined edge geometry is created with a plurality of laser beams at different angles to the workpiece surface.

DE 199 52 331 C1 delivers a higher cutting speed and higher cutting accuracy compared to the prior art cited therein, in which a method according to WO 93/20015 (identical to EP 0 633 867 B1) is described as comparatively superior and as being successful in practice. In order to achieve higher outputs, it is suggested that a plurality of laser beam bundles are guided along the cutting line one behind the other. For this purpose, optical means are provided in a device for carrying out a method of this type which allow the laser beam bundles to be guided in a coupled manner in such a way that the laser beams are focused and separate from one another or are guided on the severing line so as to be completely or partially overlapping.

US 2002/0006765 A1 describes a device for severing breakable material in which elliptically shaped beam bundles coming from a laser with beamsplitting optics arranged downstream or from two lasers are guided on a workpiece surface along a desired severing line. The semiaxes of the two beam bundles are each oriented in direction of the severing line. Depending on their distance from one another, which can also be zero, a beam profile is formed which differs toward the severing line and which can be a Gaussian profile, a so-called head-and-shoulders profile, or two Gaussian profiles.

None of the four references (WO 96/20062, DE AS 1 244 346, DE 199 52 331 C1, US 2002/0006765) in which more than one laser beam bundle is directed to the material to be severed suggests adapting the latter to one another such that a beam spot is formed with a radiation density distribution that is asymmetric to the semiaxis of the beam spot.

The seemingly infinite number of publications and, in particular, granted patents for severing brittle material by inducing thermomechanical stresses and the at times seemingly contradictory solutions offered therein, as well as practical experience, show that the individual solutions are each more or less advantageous individually for certain examples of application. Many different beam spot shapes and radiation density distributions over the beam spot in connection with the beam spot size, the radiation output and the forward feed speed are more or less suitable depending upon the material, particularly as regards the thermal conductivity and the material thickness.

For example, depending on the specific application, it may be advantageous or disadvantageous when the radiation density maximum lies in the center of the severing line as, for example, in WO 93/20015 (identical to EP 0 633 867 B1) or DE 199 52 331 C1or when the radiation density maximum lies on the severing line as described in DE 197 15 537 C2.

### INVESTIGATIONS OF THE INVENTORS

Further, the present inventors have determined through practical trials that it is advantageous for various applications when the beam spot has an elevated radiation density (hereinafter: radiation peak) along the severing line at the end or at the beginning of a beam spot that is drawn out along the severing line, i.e., when the radiation density distribution is asymmetric to the semiaxis of the beam spot intersecting the severing line. The operating speed and the cutting quality can be influenced by the position and the height of the radiation peak depending upon the material and its thickness.

However, in practice, a beam spot of the type mentioned above has the disadvantage that the machining direction cannot be reversed. This means that when, for example, a plate is to be divided into individual parallel strips starting from a first edge, the laser must always first be moved back to this first edge or, when the laser is stationary, this first edge must be positioned relative to the laser so that the operating parameters are identical for each step. When this cutting mode is implemented mechanically, there is an idle time of approximately 50%.

### OBJECT AND SUMMARY OF THE INVENTION

It is the primary object of the invention to provide a method in which a brittle material is severed by inducing a thermomechanical stress by means of a laser beam with asymmetric radiation density distribution in the beam spot, wherein the severing cut can advantageously be carried out bidirectionally, i.e., in alternating directions.

This object is met for a method of the present invention for severing a flat workpiece of brittle material by inducing thermomechanical stresses along severing lines by use of lasers, comprising the following steps: adjusting a predetermined output E1 at a first laser and adjusting an output E2 differing from E1 at a second laser, each laser generating a laser beam bundle; directing the two laser beam bundles to the surface of the workpiece to be severed, where each of them has an elliptic beam spot geometry which is determined in each instance by a major semiaxis and a minor semiaxis so that their major semiaxes both lie on a severing line so as to partially overlap, so that the two beam spots of the two laser beam bundles form a common elliptic beam spot whose radiation density distribution is asymmetric to its minor semiaxis; moving the laser beam bundles relative to the workpiece in the direction determined by the severing line; and directing a coolant flow to the workpiece behind the laser beam spot with respect to the movement direction.

### BRIEF DESCRIPTION OF THE DRAWING

FIG. 1 illustrates in graphical form a radiation density distribution of the two laser beam bundles and an asymmetrical radiation distribution, which occurs due to overlapping of the two laser beam bundles.

The invention will be described in more detail in the following with reference to an embodiment example.

### DESCRIPTION OF THE PREFERRED EMBODIMENTS

In an embodiment example, a wafer of sapphire with a diameter of 2″ and a thickness of 90 μm must be cut into chips with an edge length of 320 μm. For this purpose, severing cuts are generated in the wafer with a spacing of 320 μm first in the X-direction and then in the Y-direction. According to the invention, the severing cuts in the X-direction and the severing cuts in the Y-direction are started alternately from opposite outer edges, i.e., the respective subsequent cut starts at an offset of 320 μm at the circumference of the wafer disk where the previous severing cut ended. In order to carry out the severing cut at the same operating speed and with the same cut quality regardless of the direction of the relative movement (bidirectionally) between the laser beam bundle and the wafer, the prevailing conditions must be absolutely identical regardless of the direction and must be adjustable easily and quickly.

In order to sever a wafer disk of sapphire as in the present case in the first embodiment example, it has proven advantageous in practice when a radiation density distribution in the beam spot has an elevated radiation density (radiation peak) at the end in the movement direction.

According to the invention, a radiation density distribution of this kind is generated by overlapping two elliptic laser beam bundles with a Gaussian radiation density distribution and different output.

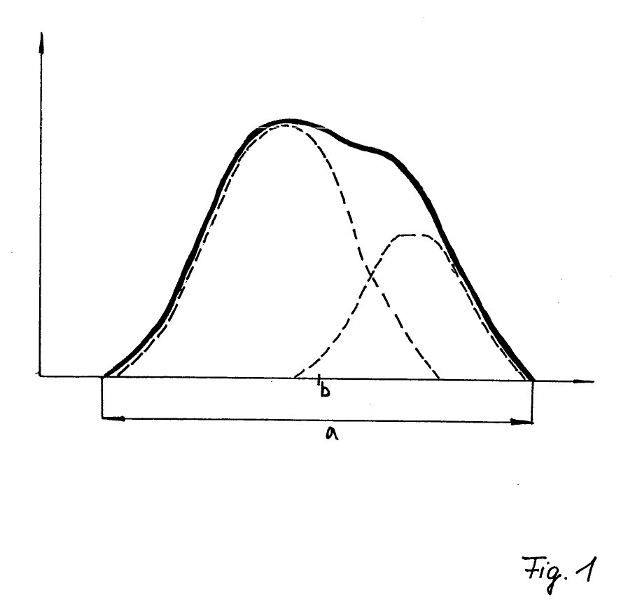

FIG. 1 shows a radiation density distribution of the two laser beam bundles (dashed lines) and an asymmetric radiation density distribution (solid line), which occurs due to the overlapping of the two laser beam bundles, in the common beam spot along its major semiaxis b. The asymmetry relative to the intersection a of the minor semiaxis perpendicular to the major semiaxis b of the common beam spot, which major semiaxis b extends in the severing direction T, is clearly shown.

In order to obtain a radiation density distribution in the common beam spot with a radiation peak at the end, the selected output of the laser whose radiation is directed to the surface behind the radiation of the other laser with reference to the movement direction must be higher. The profile of the radiation density distribution is determined by the output of the two lasers, particularly the difference in output and the degree of overlap.

The radiation density distribution in the common beam spot can also be influenced additionally in that the two laser beam bundles generate beam spots of different sizes on the workpiece surface, i.e., beam spots with minor semiaxes of different length and/or major semiaxes of different length. The presets for the output that is adjusted at the two lasers, for the degree of overlap, and for the ratio of the dimensions of the overlapping beam spots depend on the material to be severed and on the material thickness and are optimized by trial and error and then preset in a corresponding manner.

Regardless of the ratio of the predetermined output for the two lasers, the degree of overlap and the ratio of sizes, a beam spot with a mirror-symmetric radiation density distribution occurs when the output settings of the lasers and the ratio of sizes, insofar as it is not zero, are reversed.

Corresponding to known methods from the prior art, the laser radiation is directed to the surface of the wafer and is guided along the first severing line relative to the wafer. A cooling spot following the common beam spot is generated by means of a coolant jet that is likewise guided along the severing line.

In order that severing cuts in the same direction can be severed by a relative movement in different directions according to the invention, the output of the lasers, and insofar as the size ratio is not equal to 1, is switched after every cut, a step which is less time-consuming, for example, than changing the position of specific optical components such as a diffractive element by which a specific radiation density distribution is caused.

While only a specific radiation density distribution can be realized by means of a diffractive element, it can be varied over the different parameters by the present invention and optimized for the specific application.

In further tests, ceramic substrates of 96-percent AL₂O₃ and float glass were successfully severed by the method according to the invention.

Apparatus suitable for carrying out the method requires:
two lasers with an identical beam characteristic with adjustable laser output;
optical means by which the two laser beam bundles are guided on the workpiece with a predetermined degree of overlap so that their beam spots result in a common beam spot;
means for applying a flow of coolant to the severing lines; and
means for generating a relative movement between the laser beam bundles and the coolant flow on the one hand and the workpiece on the other hand.
The means for generating the relative movement are advantageously suitable for carrying out the relative movement in alternating directions.
The means for applying a flow of coolant must be suitable for cooling the severing line that is heated by the laser radiation, i.e., the coolant flow must be directed to the severing line so as to track the laser beam. For a relative movement with alternating directions this can be realized by means of a swivelable coolant nozzle or by installing two cooling nozzles in a stationary manner by which the coolant can be dispensed selectively.
Means for beam shaping are also advantageously provided so as to allow the size of the two overlapping beam spots to be varied in dimensions.

While the foregoing description and drawings represent the present invention, it will be obvious to those skilled in the art that various changes may be made therein without departing from the true spirit and scope of the present invention.

What is claimed is:

1. A method for severing a flat workpiece of brittle material by inducing thermomechanical stresses along severing lines by use of lasers, comprising the following steps:
adjusting a predetermined output E1 at a first laser and adjusting an output E2 differing from E1 at a second laser, each laser generating a laser beam bundle;
directing the two laser beam bundles to the surface of the workpiece to be severed, where each of them has an elliptic beam spot geometry which is determined in each instance by a major semiaxis and a minor semiaxis so that their major semiaxes both lie on a severing line so as to partially overlap, so that the two beam spots of the two laser beam bundles form a common elliptic beam spot whose radiation density distribution is asymmetric to its minor semiaxis;
moving the laser beam bundles relative to the workpiece in the direction determined by the severing line; and
directing a coolant flow to the workpiece behind the laser beam spot with respect to the movement direction.

2. The method according to claim 1, wherein the workpiece is cut along severing lines of the same direction in a plurality of strips, wherein the output E1 or E2 of the other respective laser is adjusted at the end of a severing cut so that the output adjusted in the second laser for every even-numbered cut is adjusted for the first laser for every odd-numbered cut, and vice versa, and in that the severing cuts are carried out in alternating directions.

3. The method according to claim 1, wherein the minor semiaxes and the major semiaxes of the two laser beam bundles are selected differently by presetting a ratio of sizes not equal to 1 in order to influence the radiation density distribution of the common beam spot.

4. The method according to claim 2, wherein the ratio of sizes for the two laser beam bundles is reversed after the end of a severing cut.

5. The method according to claim 3, wherein the ratio of sizes for the two laser beam bundles is reversed after the end of a severing cut.
